(19) United States
(12) Patent Application Publication
(10) Pub. No.: US 2018/0038276 A1
(43) Pub. Date: Feb. 8, 2018

(54) METALLIC MICROSPHERE THERMAL BARRIER COATING

(71) Applicant: GM GLOBAL TECHNOLOGY OPERATIONS LLC, Detroit, MI (US)

(72) Inventors: Russell P. Durrett, Bloomfield Hills, MI (US); Paul M. Najt, Bloomfield Hills, MI (US); Peter P. Andruskiewicz, IV, Ann Arbor, MI (US); Tobias A. Schaedler, Oak Park, CA (US); Gary P. Hill, Sunland, CA (US); Shanying Cui, Calabasas, CA (US)

(73) Assignee: GM GLOBAL TECHNOLOGY OPERATIONS LLC, Detroit, MI (US)

(21) Appl. No.: 15/230,658

(22) Filed: Aug. 8, 2016

(51) Int. Cl. F02B 77/11; B05D 1/18; H01M 8/02; B05D 1/02

(52) U.S. Cl. CPC F02B 77/11; B05D 1/02; B05D 1/18; H01M 8/02

(57) ABSTRACT

A metallic thermal barrier coating for a component includes an insulating layer having a plurality of metallic microspheres applied to a substrate. A second metallic non-permeable layer is bonded to the insulating layer such that the sealing layer seals against the insulating layer. A method for applying a thermal barrier coating to a component includes placing an insulating layer having a plurality of microspheres to a surface of the substrate of the component. A heat treatment is applied to the insulating layer. A second non-permeable layer is bonded to and seals against the insulating layer.

### TECHNICAL FIELD

The present disclosure relates to a thermal barrier coating for an internal combustion engine.

### BACKGROUND

Some vehicles include an engine assembly for propulsion. The engine assembly may include an internal combustion engine and a fuel injection system. The internal combustion engine includes one or more cylinders. Each cylinder defines a combustion chamber. During operation, the internal combustion engine combusts an air/fuel mixture in the combustion chamber in order to move a piston disposed in the cylinder. Maintaining temperature environments in engine assemblies may be limited based upon the configuration of the engine assembly and the functions of various components.

### SUMMARY

A thermal barrier coating comprises insulating layer applied to a surface of a substrate. The insulating layer comprises a plurality of microspheres. A sealing layer is bonded to the insulating layer. The sealing layer is non-permeable such that the sealing layer seals against the insulating layer. The insulating layer may have a porosity of at least 80% and have a thickness of between about 100 microns and about 1 millimeter.

The insulating layer may further comprise a matrix material configured to bond with the plurality of microspheres. The plurality of microspheres may include a base surface formed of at least one of a metal alloy, polymer or ceramic. A first coating of nickel may be applied to the base surface of the plurality of hollow microspheres. One or more of a second coating and a third coating of at least one alloying element is applied to the first coating. The second coating may comprise nanoparticles applied to the first coating. The sealing layer may have a thickness of between about 1 micron and about 20 microns.

In another embodiment of the disclosure, a method for applying a thermal barrier coating to a component comprises placing an insulating layer of the thermal barrier coating on a substrate of the component. The insulating layer may include a matrix material configured to bond with a plurality of microspheres. A heat treatment is applied to the insulating layer on the surface of the substrate. A sealing layer of the thermal barrier coating is bonded to the insulating layer. The sealing layer is non-permeable such that the sealing layer seals against the insulating layer.

The insulating layer of the thermal barrier coating may be formed by providing a plurality of microspheres, wherein each of the plurality of microspheres includes a base surface. A first coating including a nickel alloy is applied to the base surface, while a second coating that includes one or more of aluminum, chromium and nanoparticles is applied to the first coating. The first and second coating may be applied by one or more of electroless plating, chemical vapor deposition, and physical vapor deposition.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, diagrammatic view of a vehicle illustrating a side view of a single cylinder internal combustion engine having a thermal barrier coating disposed on a plurality of components;

FIG. 2 is a schematic cross-sectional side view of the thermal barrier coating disposed on the component;

FIGS. 3A-3C are schematic cross-sectional side views of microspheres of the thermal barrier coating as formed in accordance with the present disclosure;

FIGS. 4A-4B are schematic cross-sectional side views of microspheres of the thermal barrier coating bonded with a matrix material as applied to a substrate of the component; and

FIGS. 5A-5B is a schematic cross-sectional side view of the thermal barrier coating disposed on the component illustrating the insulating and sealing layers of the thermal barrier coating applied to the substrate.

### DETAILED DESCRIPTION

Reference will now be made in detail to several embodiments of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Referring to the drawings, wherein like reference numbers correspond to like or similar components throughout the several Figures, a portion of a vehicle 10 with a propulsion system 12 in accordance with an exemplary embodiment of the disclosure is shown schematically in FIG. 1. The propulsion system 12 may be any of an internal combustion engine, fuel cells, motors and the like. The propulsion system 12 may be part of the vehicle 10 that may include a motorized vehicle, such as, but not limited to, standard passenger cars, sport utility vehicles, light trucks, heavy duty vehicles, minivans, buses, transit vehicles, bicycles, robots, farm implements, sports-related equipment or any other transportation apparatus. For purposes of clarity, propulsion system 12 will be referred to hereinafter as an internal combustion engine or engine 12.

The engine 12 of vehicle 10 may include one or more components 14. The component 14 has a thermal barrier coating (TBC) 16 of the type disclosed herein, applied thereto. In one embodiment of the disclosure, TBC 16 may include a composite or multi-layer structure or configuration. While the vehicle 10 and the engine 12 of FIG. 1 are a typical example application, suitable for the TBC 16 disclosed herein, the present design is not limited to vehicular and/or engine applications.

Any stationary or mobile, machine or manufacture, in which a component thereof is exposed to heat may benefit from use of the present design. For illustrative consistency, the vehicle 10 and engine 12 will be described hereinafter as an example system, without limiting use of the TBC 16 to such an embodiment.

FIG. 1 illustrates an engine 12 defining a single cylinder 18. However, those skilled in the art will recognize that the present disclosure may also be applied to components 14 of engines 12 having multiple cylinders 26. Each cylinder 18 defines a combustion chamber 22. The engine 12 is configured to provide energy for propulsion of the vehicle 10. The engine 12 may include but is not limited to a diesel engine or a gasoline engine. The engine 12 further includes an intake assembly 28 and an exhaust manifold 30, each in fluid communication with the combustion chamber 22. The engine 12 includes a reciprocating piston 20, slidably movable within the cylinder 18.

The combustion chamber 22 is configured for combusting an air/fuel mixture to provide energy for propulsion of the vehicle 10. Air may enter the combustion chamber 22 of the engine 12 by passing through the intake assembly 28, where airflow from the intake manifold into the combustion chamber 22 is controlled by at least one intake valve 24. Fuel is injected into the combustion chamber 22 to mix with the air, or is inducted through the intake valve(s) 32, which provides an air/fuel mixture. The air/fuel mixture is ignited within the combustion chamber 22. Combustion of the air/fuel mixture creates exhaust gas, which exits the combustion chamber 22 and is drawn into the exhaust manifold 30. More specifically, airflow (exhaust flow) out of the combustion chamber 22 is controlled by at least one exhaust valve 26.

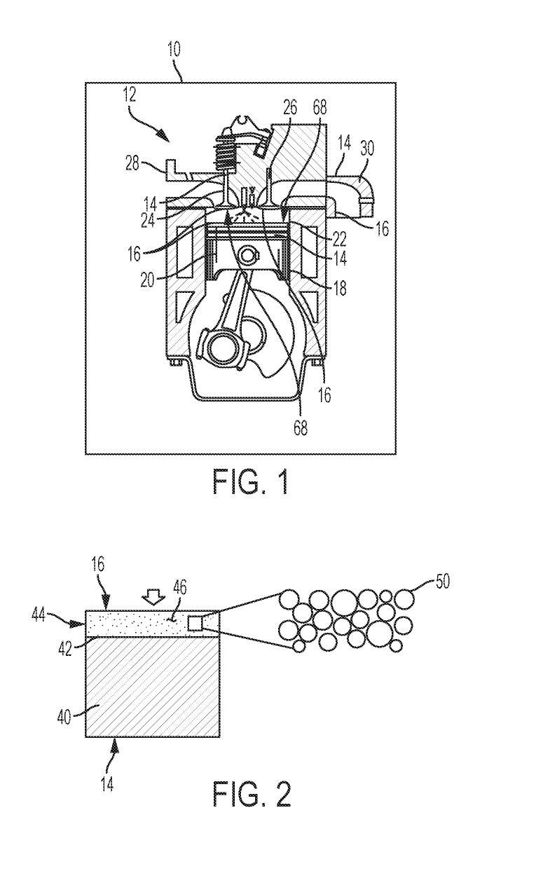

With reference to FIGS. 1 and 2, the TBC 16 may be disposed on a face or surface of one or more of the components 14 of the engine 12, including, but not limited to, the piston 20, the intake valve 24, exhaust valve 26, interior walls of the exhaust manifold 30, and the like. In one embodiment of the disclosure, the TBC 16 may be applied onto high temperature sections or components of the engine 12 and bonded to the component 14 to form an insulator configured to reduce heat transfer losses, increase efficiency, and increase exhaust gas temperature during operation of the engine 12.

The TBC 16 is configured to provide low thermal conductivity and low heat capacity to increase engine efficiency. As such, the low thermal conductivity reduces heat transfer losses and the low heat capacity means that the surface of the TBC 16 tracks with the temperature of the gas during temperature swings and heating of cool air entering the cylinder is minimized. In one non-limiting embodiment of the disclosure, the TBC 16 may be about 200 microns (μm) in thickness that is applied to a surface 42 of the component 14 which exhibits a calculated thermal conductivity of about 0.36 W/mK and heat capacity of 289 kJ/m3K, a porosity of about 92.5%, crushing strength of about 10 MPa to minimize heat losses and could increase engine efficiency by 5-10%.

For example, a TBC 16 for the engine 12 may be desired that insulate the hot combustion gas from the lower temperature water-cooled engine block to avoid energy loss by transferring heat from the combustion gas to the cooling water. Further, during the intake cycle, the insulation material should cool down rapidly in order to not heat up the fuel-air mixture before ignition to avoid abnormal combustion caused by heat being retained within the combustion chamber 22. It should be appreciated that the TBC 16 may be applied to components other than present within the engine 12. More specifically, the TBC 16 may be applied to components of spacecraft, rockets, injection molds, and the like.

Referring now to FIG. 2, each component 14 includes a substrate 40 having at least one exterior or presenting surface 42. The TBC 16 may include at least one layer 44 that is applied and/or bonded to the surface 42 of the substrate 40. The at least one layer 44 of the TBC 16 may include multiple layers, such as a first or insulating layer 46, and a second or sealing layer 48.

The insulating layer 46 may include a plurality of hollow microspheres 50, sintered together to create a layer having an extremely high porosity and mostly closed celled structure. Preferably, the porosity of the insulating layer 46 may be at least about 80%. The high porosity of the insulating layer 46 provides for a corresponding volume of air and/or gases to be contained therein, thus providing the desired insulating properties of low effective thermal conductivity and low effective heat capacity.

It is contemplated that the higher the volume fraction of porosity in the first coating 62, the lower the thermal conductivity and capacity. The porosity level needs to be balanced with the mechanical requirements, such as compressive strength, which is required to withstand the high pressure levels in the engine 12. The thickness T1 of the insulating layer may be between about 50 microns or micrometers (μm) and 1000 μm or 1 millimeter (mm). More preferably, the thickness T2 of the sealing layer may be between about 1 μm and about 20 μm. The insulating layer 46 is configured to withstand pressures of around 100 bar and withstand surface temperatures of around 1,100 degrees Celsius (° C.).

The hollow microspheres 50 may be comprised of a combination of polymeric, metal, glass, and/or ceramic materials. In one non-limiting embodiment, the hollow microspheres 50 are comprised of metal, such as Nickel (Ni), nickel alloy compounds, Iron-Chromium-Aluminum (FeCrAl) alloys, Cobalt (Co) alloys and the like for durability and resistance to oxidation and corrosion at high temperatures of around 1,000 degrees Celsius (° C.). The hollow microspheres 50 may have a diameter D1 of between about 10 μm and about 100 μm. The wall thickness of the hollow microspheres may be between about 0.5 micron and 5 microns.

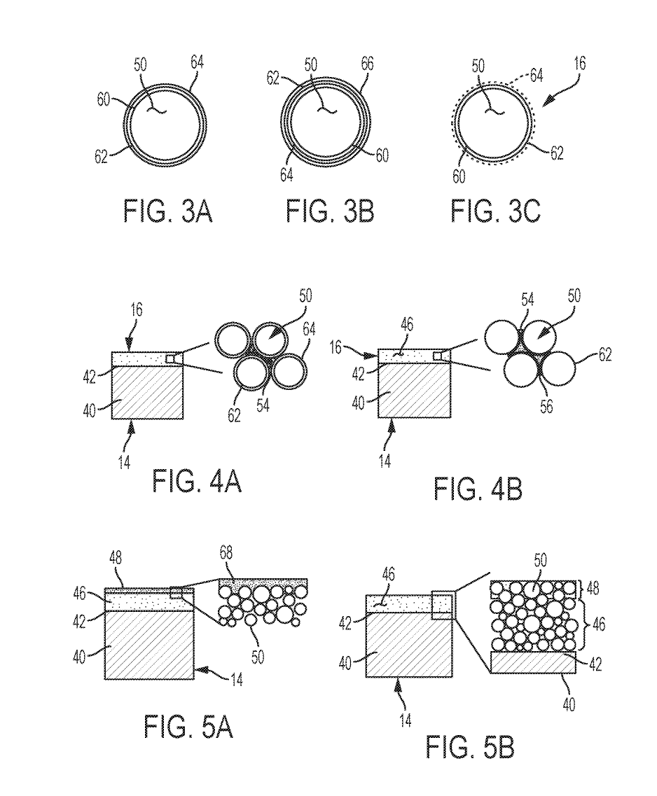

Referring now to FIG. 3, microspheres 50 are illustrated that may be formed by a variety of processes. A microsphere 50 may be formed with a base surface, generally referenced by numeral 60. The base surface 60 may be formed of a polymeric material to provide a spherical shaped template for the microsphere 50. The polymeric material may be advantageous for the base surface 60 to limit conductivity and heat capacity as part of the completed microsphere 50.

The base surface 60 may be formed using a variety of materials, including, but not limited to, polyvinylidene chloride copolymer for a hollow microsphere 50, a polystyrene for a solid microsphere 50 that may be removed at a later step in the formation process. Alternatively, hollow spheres formed using ceramics such as glass bubbles or cenospheres such as fillite, can also be used but may not be removed in the formation process.

A first coating 62 is applied to at least a portion of the base surface 60. In one embodiment of the disclosure, the first coating 62 may comprise a material such as nickel that is applied or deposited over substantially the entire base surface 60 via electroless plating or a chemical vapor deposition (CVD) process. It is also appreciated that another material, such as iron or cobalt could be used as the first coating 62 material in place of nickel.

The thickness of the first coating 62 may be tailored by adjusting the amount of time of the plating process at a specified temperature, for example between about 0.2 μm and about 2 μm of nickel may be deposited depending on the diameter D1 of the base surface 60 and the target density of the insulating layer 46. In one embodiment, the TBC 16 with a higher porosity will exhibit a lower thermal conductivity and heat capacity, while decreasing the strength and robustness of the insulating layer 46. As such, a porosity between about 90% and about 97% of the insulating layer 46 is preferred.

A second coating 64 may then be applied and/or deposited over at least a portion of the first coating 62. The second coating 64 may be a material that forms an alloy with the first coating 62. In one embodiment the first coating contains nickel and the second coating contains at least one or more elements, including, but not limited to, Zinc (Zn), Copper (Cu), chromium (Cr), aluminum (Al), cobalt (Co), Molybdenum (Mo), Tungsten (W), Tantalum (Ta), Titanium (Ti), Zirconium (Zr), Hafnium (Hf) and/or Yttrium (Y). It is advantageous for the second coating 64 to form an alloy with the first coating, as pure nickel provides limited strength and oxidation and corrosion resistance at elevated temperatures.

The alloying material of the second coating 64 may be applied to at least a portion of the first coating 62 by an electroless plating, CVD, vapor phase deposition process or dry sputtering. Referring to FIGS. 3A-3C, various configurations of microspheres 50 for use in the TBC 16 are illustrated. FIG. 3A illustrates microsphere 50 including a base polymeric surface 60 at least partially covered by a first coating 62 comprising nickel. The second coating 64 comprising one alloying element, such as chromium or aluminum, which at least partially covers the first coating 62.

It is understood that the materials used with the base surface 60 of microsphere 50, first coating 62 and second coating 64 may be adjusted without affecting the functionality of the microsphere 50. In one embodiment of the disclosure, the second coating 64 may be chromium that is about 5% to about 30% of the thickness of the first coating 62. In another embodiment of the disclosure, the second coating 64 may be aluminum that is about 5% to about 30% of the thickness of the first coating.

FIG. 3B illustrates an alternative configuration for microsphere 50. Microsphere 50 includes a base polymeric, glass or ceramic surface 60 at least partially covered by a first coating that comprises mostly nickel or cobalt or iron and is deposited by electroless plating or CVD. The second coating 64 comprises a first alloying element, such as chromium or aluminum, which at least partially covers the first coating 62. A third coating 66 of a second alloying element at least partially covers the second coating 62. In one embodiment of the disclosure, the coating thicknesses are configured to yield the ratio of elements of the target alloy. One embodiment of the ratio of elements may be a nickel alloy with about 22% by weight of chromium and about 10% by weight of aluminum to produce hollow microspheres 50 with a 50 μm diameter and 1 μm shell thickness.

In this embodiment, a first coating 62 of about 0.53 μm of nickel is deposited on the base surface 60, followed by a second coating 64 of about 21 μm chromium and then a third coating 66 of about 26 μm aluminum. After application of the first coating 62, second coating 64 and third coating 66, microspheres 50 may be subjected to a homogenization heat treatment of about 1200 degrees Celsius (° C.) for 48 hours to interdiffuse the elements in the three coatings and form a homogeneous alloy. An optional ageing heat treatment of about 900 degrees Celsius (° C.) for 8 hours or a similar time and temperature may be performed to form precipitates that strengthen the nickel alloy.

In another embodiment the outer coating, either the second or third coating depending on how many coatings are deposited, is selected from a group of materials including Zinc (Zn), Copper (Cu), Silver (Ag) and Aluminum (Al) that exhibit a lower melting point than the first coating and therefore promote sintering of the microspheres to each other and to the substrate and sealing layer.

Alternatively, as is shown in FIG. 3C, the second coating 64 may include nanoparticles containing the alloying elements with diameters of about 20 nanometers (nm) to about 500 nm may be applied to the first coating 62. The nanoparticles, which may contain Inconel® alloys, nickel base superalloys or stainless steel, may be diffused into the first coating 62 using heat treatments of between about 1000 degrees Celsius (° C.) and about 1100 degrees Celsius (° C.) for a period of about 10 hours to about 20 hours. The first coating may comprise mostly nickel, cobalt or iron deposited by electroless plating of CVD. The heat treatments may be performed after a TBC 16 coating has been applied to a substrate, but they could also be performed before application to the substrate. In one embodiment of the disclosure, the second coating 64 of nanoparticles may be comprised of Inconel® alloy or nickel based superalloy particles having a diameter of about 20 nm to about 200 nm with the coating being about 5% to about 30% of the thickness of the first coating 62.

Referring back to FIG. 2, application of the first or insulating layer 46 to the surface 42 of the substrate 40 is described in greater detail. In one embodiment the microspheres 50 are placed on the substrate 40 and sintered at an elevated temperature that ensures diffusion between the microspheres themselves and the substrate. In another embodiment, microspheres 50 are placed in a slurry. The slurry may be formed of a solvent, such as water, and a water soluble binder, for example polyvinyl-alcohol, polyvinyl-pyrrolidone or cellulose polymer derivatives. An organic solvent such as isopropanol or acetone can also be added to water or fully substituted for the solvent in which case the binder must be suitably soluble in the mixture, such as a polyvinyl butyral resin. Other slurry additives, for example polyethylene-glycol and glycerol, may be used for rheological adjustments such as deflocculation, lubrication, and antifoaming to maximize the packing efficiency upon slurry application.

Preferably the slurry is fluidized for application by addition of just enough solvent to flow smoothly, for example about 10 milliliters (ml) for 10 grams (g) of dry microspheres 50 and a minimum amount of binder is also added to reduce residual carbon after burnout. The first or insulating layer 46 may be formed by applying a slurry of the microspheres 50 to the surface 42 of substrate 40 by spray coating, dipping, painting, doctor-blading or other methods.

After application, the coating is dried to remove the solvent and then sintered at a temperature that ensures diffusion between the microspheres 50 themselves and between the microspheres 50 and the substrate 40. Sintering is typically carried out in an inert or reducing atmosphere. The organic components of the slurry can either be removed during a separate burn-out heat treatment in air at 400-600 degrees Celsius (° C.) before sintering or during the sintering step.

Referring to FIGS. 4A and 4B, in one embodiment of the disclosure, microspheres 50 including at least one coating such as the first coating 62 and the second coating 64 may be combined with particles 54 of a matrix forming alloy, generally referred to by numeral 56 to be applied to the surface 42 of substrate 40. FIG. 4A4A illustrates a portion of the TBC 16 prior to heating, wherein particles 54 are positioned in cavities between adjacent microspheres 50. Particles 54 combine in matrix 56 with microspheres 50 to increase structural durability and robustness of the insulating layer. It is contemplated that particles 54 may be added to the slurry to form the matrix 56.

To increase the strength of the first coating 62 and/or second coating 64, either the thickness of the microspheres 50 or the volume fraction of matrix 56 may be increased. Upon heat treatment, the matrix forming particles 54 generate the matrix 56, the density of which may be dependent upon the volume fraction of matrix material 56. The matrix forming particles 54 may be less than 50 μm in diameter and may represent no more than about 10% by weight to about 20% by weight of the insulating layer 46. Further particles 54 and matrix 56 may exhibit a lower melting point, for example, less than 1100 degrees Celsius (° C.), than the microspheres 50 to enable sintering of the matrix 56 or create a small amount of liquid phase to fuse adjacent microspheres together and distribute the liquid throughout the first coating 62 and/or second coating 64.

Non-limiting examples of materials for particles 54 include, but are not limited to, aluminum alloys, pure aluminum, nickel alloys with about 1% by weight to about 10% by weight of Boron (B), nickel alloys with about 1% by weight to about 10% by weight of Phosphorous (P), nickel alloys with about 1% by weight to about 15% by weight of Silicon (Si) or mixtures thereof. It is also contemplated that the particles 54 may contain additional alloying elements including chromium, aluminum, cobalt, molybdenum, tungsten, tantalum, titanium, zirconium, hafnium and/or yttrium.

A coating of the slurry is applied to the surface 42 of the substrate 40 of the component 14, such as a piston head, valve or an exhaust port. The coating may be applied by a number of non-limiting methods, including spray coating, dipping, painting, doctor-blading and the like to a coating thickness of between about 100 μm and 1 mm. The slurry coating 52 may be heated at a temperature of about 100 degrees Celsius (° C.) to about 300 degrees Celsius (° C.) for about 1 hour to about 5 hours to dry the coating.

The slurry coating of hollow microspheres 50 may be molded or sintered under pressure, while being heated, over a molding time, until the insulating layer 46 is formed. For example, the slurry may be sintered at a temperature of about 800 degrees Celsius (° C.) to about 1100 degrees Celsius (° C.) for about 2 to about 20 hours. During the sintering heat treatment, microspheres 50 fuse together with the substrate to improve structural integrity. Diffusional mixing of the alloying elements and the nickel base metal may result in a nickel alloy with more than 10% by weight Chromium and more than 4% by weight aluminum and a ratio of aluminum to Chromium greater than 0.25 to form an aluminum oxide for oxidation resistance at temperatures above 900 degrees Celsius (° C.). If iron or cobalt is chosen as a base material in place of nickel, similar Fe—Cr—Al or Co—Cr—Al alloys may be used to achieve similar results.

Referring now to FIGS. 5A and 5B, the sealing layer 48 is disposed over the insulating layer 46, such that the insulating layer 46 is disposed between the sealing layer 48 and the surface 42 of the substrate 40 of the component 14. The sealing layer 48 may be a high temperature thin film. More specifically, the sealing layer 48 comprises material that is configured to withstand temperatures of at least 1100 degrees Celsius (° C.). The sealing layer 48 may be configured to be a thickness of about 1 μm to about 20 μm.

The sealing layer 48 may be non-permeable to combustion gases, such that a seal is provided between the sealing layer 48 and the insulating layer 46. Such a seal prevents debris from combustion gases, such as unburned hydrocarbons, soot, partially reacted fuel, liquid fuel, and the like, from entering the porous structure defined by the hollow microspheres 50. If such debris were allowed to enter the porous structure of the insulating layer 46, air disposed in the porous structure would end up being displaced by the debris, and the insulating properties of the insulating layer 46 would be reduced or eliminated.

The sealing layer 48 may be configured to present an outer surface 68 that is smooth. Having a smooth sealing layer 48 may be important to prevent the creation of turbulent airflow as the air flows across the outer surface 68 of the sealing layer 48. Further, having a sealing layer 48 with a smooth surface will prevent an increased heat transfer coefficient. In one non-limiting example, the sealing layer 48 may be applied to the insulating layer 46 via electroplating. In another non-limiting example, the sealing layer 48 may be a thin film comprised of metals including nickel, nickel alloy, cobalt alloy, iron alloy or steel that is applied to the insulating layer simultaneously with or after sintering the insulating layer 46.

The sealing layer 48 is configured to be sufficiently resilient so as to resist fracturing or cracking during exposure to debris. Further, the sealing layer 48 is configured to be sufficiently resilient so as to withstand any expansion and/or contraction of the underlying insulating layer 46. Further, the insulating and sealing layers 46, 48 are each configured to have compatible coefficient of thermal expansion characteristics to withstand thermal fatigue.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A thermal barrier coating applied to a surface of a substrate comprising:
an insulating layer applied to the surface of the substrate, the insulating layer having a thickness of between about 50 microns and about 1 millimeter, the insulating layer including a plurality of microspheres and a porosity of at least 80%, wherein each of the plurality of microspheres includes a base surface, a first coating applied to at least a portion of the base surface, and a second coating applied to at least a portion of the first coating, wherein the second coating includes at least one alloying element forming an alloy with the first coating; and
a sealing layer bonded to the insulating layer, wherein the sealing layer is non-permeable such that the sealing layer seals against the insulating layer.

2. The thermal barrier coating of claim 1 wherein the insulating layer further comprises a matrix material bonded with the plurality of microspheres.

3. The thermal barrier coating of claim 1 wherein the plurality of microspheres are hollow and the base surface is formed of at least one of a metal alloy, polymer, glass and ceramic.

4. The thermal barrier coating of claim 1 wherein the first coating comprises at least one or more of nickel, copper, cobalt, iron, or chromium.

5. (canceled)

6. The thermal barrier coating of claim 1 wherein the at least one alloying element of the second coating is selected from the group consisting of: zinc, copper, iron, chromium, aluminum, cobalt, molybdenum, tungsten, tantalum, titanium, zirconium, hafnium and yttrium, wherein the at least one alloying element of the second coating combines with the first coating to form the alloy.

7. The thermal barrier coating of claim 1 wherein the second coating includes nanoparticles that are applied to the first coating.

8. The thermal barrier coating of claim 1 wherein the sealing layer has a thickness of between about 1 microns and about 20 microns.

9. The thermal barrier coating of claim 8 wherein the sealing layer further comprises one or more metals selected from the group consisting of: nickel, nickel alloys, cobalt alloys, iron alloys, refractory alloys and stainless steel.

10. A component comprising:
a substrate presenting a surface; and
a thermal barrier coating including:
an insulating layer applied to the surface of the substrate, the insulating layer having a thickness of between about 50 microns and about 1 millimeter, the insulating layer including a plurality of microspheres, wherein each of the plurality of microspheres includes a base surface, a first coating applied to at least a portion of the base surface, and a second coating applied to at least a portion of the first coating, wherein the second coating includes at least one alloying element forming an alloy with the first coating; and
a sealing layer bonded to the insulating layer, wherein the sealing layer is non-permeable such that the sealing layer seals against the insulating layer.

11. The component of claim 10 wherein the sealing layer has a thickness of between about 1 microns and about 20 microns.

12. The component of claim 11 wherein the sealing layer further comprises one or more metals selected from the group consisting of: nickel, nickel alloys, cobalt alloys, iron alloys, refractory alloys and stainless steel.

13. The component of claim 10 wherein the plurality of microspheres are hollow and the base surface is formed of at least one of a metal alloy, polymer, glass and ceramic.

14. The component of claim 10 wherein the first coating comprises at least one or more of nickel, copper, cobalt, iron, or chromium.

15. (canceled)

16. The component of claim 10 wherein the at least one alloying element of the second coating is selected from the group consisting of: zinc, copper, iron, chromium, aluminum, cobalt, molybdenum, tungsten, tantalum, titanium, zirconium, hafnium and yttrium, wherein the at least one alloying element of the second coating combines with the first coating to form the alloy.

17. The component of claim 10 wherein the second coating includes nanoparticles that are applied to the first coating.

18.

19.

20.

21. The thermal barrier coating of claim 1 further comprising a third coating applied to at least a portion of the second coating, wherein the third coating includes a second alloying element forming an alloy between the second and third coatings.

22. The thermal barrier coating of claim 21 wherein the third coating is selected from the group consisting of: zinc, copper, silver and aluminum.

23. The thermal barrier coating of claim 1 wherein the first coating is nickel and the second coating is chromium that is about 5% to about 30% of the thickness of the first coating.

24. The component of claim 10 further comprising a third coating applied to at least a portion of the second coating, wherein the third coating includes a second alloying element forming an alloy between the second and third coatings.

25. A thermal barrier coating applied to a surface of a substrate comprising:
an insulating layer applied to the surface of the substrate, the insulating layer having a thickness of between about 50 microns and about 1 millimeter, the insulating layer including a plurality of microspheres and a porosity of at least 80%, wherein each of the plurality of microspheres includes:
a base surface formed of at least one of a metal alloy, polymer, glass and ceramic,
a first coating applied to at least a portion of the base surface, and
a second coating applied to at least a portion of the first coating,
wherein the second coating includes at least one alloying element forming an alloy with the first coating; and
a sealing layer bonded to the insulating layer, wherein the sealing layer is non-permeable such that the sealing layer seals against the insulating layer.
